(19) United States
(12) Patent Application Publication
(10) Pub. No.: US 2007/0207981 A1
(43) Pub. Date: Sep. 6, 2007

(54) MICRO-ENCAPSULATION OF VOLATILE COMPOUNDS INTO CYCLODEXTRINS: A NEW TECHNOLOGY TO REDUCE POST HARVEST LOSSES

(76) Inventors: Eva Almenar, East Lansing, MI (US); Rafael Auras, Lansing, MI (US); Bruce Harte, Bath, MI (US); Maria Rubino, East Lansing, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/682,488

(22) Filed: Mar. 6, 2007

Related U.S. Application Data
(60) Provisional application No. 60/743,408, filed on Mar. 6, 2006.
(60) Provisional application No. 60/825,035, filed on Sep. 8, 2006.

(51) Int. Cl. A01N 43/04; A01N 37/00; A01N 31/00; A01N 35/00

(52) U.S. Cl. 514/58; 514/557; 514/693; 514/701; 514/724

(57) ABSTRACT

Systems are provided for preventing post harvest fungal diseases of food systems, such as but not limited to fresh produce, such as but not limited to berries (e.g., blueberries). For example, various anti-fungal compounds can incorporated or encapsulated into cyclodextrins, such as but not limited to α, β and/or γ cyclodextrins. The encapsulated anti-fungal materials can be used alone (e.g., brought into proximity to the produce) or incorporated into film and/or packaging materials that are used in the packing and/or storing of produce. By way of a non-limiting example, the anti-fungal compounds can include volatile compounds such as but not limited to acetaldehyde, hexanal and 2E-hexenal. The cyclodextrins provide controlled release of the volatiles over a period of at least several days such that they prevent or inhibit fungal growth, including but not limited to several species of the Colletotrichum, Altermaria, Botrytis, Penicillium and/or Aspergillus genera.

### CROSS-REFERENCE TO RELATED APPLICATION

The instant application claims priority to U.S. Provisional Patent Application Ser. No. 60/743,408, filed Mar. 6, 2006, and U.S. Provisional Patent Application Ser. No. 60/825,035, filed Sep. 8, 2006, the entire disclosures of both of which are expressly incorporated herein by reference.

### BACKGROUND OF THE INVENTION

1. Field of the Invention

The present invention generally relates to systems for preventing post harvest fungal diseases of produce and more specifically to antimicrobial materials, such as encapsulated anti-fungal compounds, as well as films and packaging (including those that are biodegradable and non-biodegradable) incorporating the anti-fungal compounds, for preventing post harvest fungal diseases of fresh produce, such as but not limited to berries (e.g., blueberries).

2. Description of the Related Art

Fresh produce, such as but not limited to berries (e.g. blueberries), are perishable items with a relatively short lifespan. High levels of sugars and other nutrients, along with an ideal water activity and low pH, provide a growth medium for various microorganisms, including various fungi. Post harvest losses during fresh produce storage and marketing, including but not limited to berry storage and marketing, are mainly caused by fungi such as Colletotrichum acutatum, Alternaria alternata and Botrytis cinerea. Other species of fungi that produce various post harvest diseases in fresh produce include Gliocephalotrichum microchlamydosporum, Colletotrichum gloeosporioides, Botryodiplodia theobromae, and Rhizopus stolonifer.

Additionally, Penicillium roqueforti, Penicillium expansum, and Aspergillus niger are also common contaminants of various food systems, including fresh produce. These fungi typically grow at moisture content of 15 to 20% in equilibrium with a relative humidity of 65 to 90% and temperatures up to 55° C. They are harsher when temperatures surpass 25° C. and relative humidity goes above 85%.

Control of these organisms is very difficult, even with preharvest fungicidal application. Alternative means for reducing or avoiding fungal growth in fresh produce are being studied, and one of these is the use within their environment of natural occurring plant volatiles well known for their anti-fungal effectiveness. Recently, interest in these natural substances has increased and numerous studies on their anti-fungal activity have been reported. Aroma (i.e., gaseous) compounds such as hexanal, acetaldehyde, and 2E-hexenal have shown antimicrobial activity against spoilage microbial species in vitro and in real systems. However, the main disadvantages include their volatility and premature release from the application point. That is, these volatile gaseous materials have a tendency to rapidly dissipate into the atmosphere and thus reduce their effectiveness.

Therefore, it would be advantageous to provide new and improved systems for reducing or preventing fungal growth in food systems, such as but not limited to fresh produce, such as but not limited to berries (e.g., blueberries), which overcome at least one of the aforementioned problems.

### SUMMARY OF THE INVENTION

The intended objectives of the present invention are to: (1) to develop anti-fungal materials (e.g., for use alone or in films and/or packaging) for prolonging fresh produce (e.g., berries) shelf-life; (2) to develop biodegradable active (e.g., containing an anti-fungal material) materials (e.g., for use in films and/or packaging) for prolonging fresh produce (e.g., berry) shelf-life; (3) to develop non-biodegradable active (e.g., containing an anti-fungal material) materials (e.g., for use in films and/or packaging) for prolonging fresh produce (e.g., berry) shelf-life; (4) to reduce both economic losses to fresh produce (e.g., berry) growers and producers; and (5) to reduce environmental problems related to non-degradable films/packaging and fungicides.

In accordance with one aspect of the present invention, a system is provided for the controlled release of natural anti-fungal compounds by encapsulating them into cyclodextrins, such as but not limited to α, β and/or γ cyclodextrins to form inclusion complexes (ICs).

In accordance with another aspect of the present invention, a system is provided for the controlled release of natural anti-fungal compounds (e.g., ICs) from biodegradable materials (e.g., for use in films and/or packaging) such as but not limited to poly(lactide) (PLA), as a method for controlling post harvest diseases. Additionally, the ICs can be incorporated into non-biodegradable materials, as well. These new and improved films and packaging can prolong fresh product shelf-life and can be used in active packaging to delay decay caused mainly by fungi, as well as to reduce environmental problems because these films and packaging can be made from renewable resources and can be biodegradable.

In accordance with one embodiment of the present invention, a system for inhibiting fungal growth on post harvest fresh produce is provided, comprising: (1) a volatile compound; and (2) a cyclodextrin, wherein the volatile compound is encapsulated by the cyclodextrin.

In accordance with a first alternative embodiment of the present invention, a system for inhibiting fungal growth on post harvest fresh produce is provided, comprising: (1) a volatile compound selected from the group consisting of acetaldehyde, hexanal, 2E-hexanal, and combinations thereof; and (2) a cyclodextrin, wherein the cyclodextrin is selected from the group consisting of α cyclodextrins, β cyclodextrins, γ cyclodextrins, and combinations thereof, wherein the volatile compound is encapsulated by the cyclodextrin.

In accordance with a second alternative embodiment of the present invention, a system for inhibiting fungal growth on post harvest fresh produce is provided, comprising: (1) a volatile compound selected from the group consisting of acetaldehyde, hexanal, 2E-hexanal, and combinations thereof; and (2) a cyclodextrin, wherein the cyclodextrin is selected from the group consisting of α cyclodextrins, β cyclodextrins, γ cyclodextrins, and combinations thereof, wherein the volatile compound is encapsulated by the cyclodextrin, wherein the volatile compound exhibits anti-fungal properties, wherein the volatile compound is released over a period of several days from the cyclodextrin.

Further areas of applicability of the present invention will become apparent from the detailed description provided hereinafter. It should be understood that the detailed description and specific examples, while indicating the preferred embodiment of the invention, are intended for purpose of illustration only and are not intended to limit the scope of the invention.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1a is a graphical view of the release of hexanal from inclusion complexes (ICs) obtained from different molar relationships between CD and volatiles, in accordance with one embodiment of the present invention;

FIG. 1b is a graphical view of the release of acetaldehyde from ICs obtained from different molar relationships between CD and volatiles, in accordance with one embodiment of the present invention;

FIG. 2a is a graphical view of the effectiveness of hexanal on growth of C. acutatum at 23° C., in accordance with one embodiment of the present invention;

FIG. 2b is a graphical view of the effectiveness of acetaldehyde on growth of C. acutatum at 23° C., in accordance with one embodiment of the present invention;

FIG. 3a is a graphical view of the effectiveness of hexanal on growth of A. alternata at 23° C., in accordance with one embodiment of the present invention;

FIG. 3b is a graphical view of the effectiveness of acetaldehyde on growth of A. alternata at 23° C., in accordance with one embodiment of the present invention;

FIG. 4a is a graphical view of the effectiveness of hexanal on growth of B. cinerea at 23° C., in accordance with one embodiment of the present invention;

FIG. 4b is a graphical view of the effectiveness of acetaldehyde on growth of B. cinerea at 23° C., in accordance with one embodiment of the present invention;

FIG. 5a is a graphical view of the effectiveness of ICs βCD-hexanal against C. acutatum, in accordance with one embodiment of the present invention;

FIG. 5b is a graphical view of the effectiveness of βCD-acetaldehyde against A. alternata, in accordance with one embodiment of the present invention;

FIG. 5c is a graphical view of the effectiveness of ICs βCD-hexanal against B. cinerea, in accordance with one embodiment of the present invention;

FIG. 6a is a graphical view of the effect of PLA_βCD_acetaldehyde films against A. alternata growth, in accordance with one embodiment of the present invention;

FIG. 6b is a graphical view of the effect of PLA_βCD_hexanal films against C. acutatum growth, in accordance with one embodiment of the present invention;

FIG. 7 is a graphical view of the effect of hexanal against Penicillum growth, in accordance with one embodiment of the present invention;

FIG. 8 is a graphical view of the effect of 2E-hexenal against Penicillum growth, in accordance with one embodiment of the present invention; and

FIG. 9 is a graphical view of the effect of acetaldehyde against A. niger growth, in accordance with one embodiment of the present invention.

The same reference numerals refer to the same parts throughout the various Figures.

### DETAILED DESCRIPTION OF THE INVENTION

The following description of the preferred embodiment(s) is merely exemplary in nature and is in no way intended to limit the invention, or uses.

In accordance with one embodiment of the present invention, growth of Colletotrichum acutatum, Alternaria alternata and Botrytis cinerea was evaluated in vitro in the presence of hexanal and acetaldehyde.

Cyclodextrins (CD) are naturally occurring molecules (produced enzymatically from starch) composed of glucose units arranged in a bucket shape with a central cavity. These oligosaccharides are composed of six, seven and eight anhydroglucose units, namely α, β and γ, respectively. All have a hydrophilic exterior and a hydrophobic cavity, which enables them to form inclusion complexes (IC) with a variety of hydrophobic molecules. The various cavity sizes allow for great application flexibility since ingredients with different molecular sizes can be effectively complexed. Thus, acetaldehyde and hexanal were microencapsulated in cyclodextrins to prevent premature release and so to allow slow diffusion over a long period of time. Both ICs were mixed with polylactic acid (PLA) resin (e.g., a biodegradable polymer) to form active polymer sheets. It should be noted that these biodegradable materials can be shaped into films, packaging (e.g., containers, lids and/or the like), and/or the like. The effectiveness of these active films was then tested on fresh produce pathogens, including but not limited to berry pathogens.

β-cyclodextrins (e.g., purity>99%) were provided by Wacker Chemical Corporation (Adrian, Mich.). The volatile compounds acetaldehyde (e.g., purity>99.5%) and hexanal (e.g., purity>98%) were purchased from Sigma-Aldrich Corp. (Saint Louis, Mo.). Colletotricumn acutatum, Alternaria alternata and Botrytis cinerea cultures were isolated from blueberries and provided by the Department of Plant Pathology, MSU, East Lansing, Mich. The spores were obtained in vitro from monoconidial cultures.

β-cyclodextrins were put into a beaker containing hot distilled water and stirred using a hot plate stirrer (Thermolyne® Mirak™ hot plate/stirrer; Sigma-Aldrich Corp. (Saint Louis, Mo.)). A few seconds later, 307, 610, 1230 or 1845 PI of hexanal were slowly released into the solution, and stirred for several hours at 100° C. After that, the beaker was transferred to a new stirrer plate (Thermolyne Nuova II stir plate, Barnstead International, Testware, Sparks, Nev.) for several minutes at room temperature. Finally, the sample was centrifuged and the paste obtained was dried overnight. All the samples were evaluated in triplicate and stored in hermetically closed flasks at 23° C.

β-cyclodextrins were added into a beaker containing hot distilled water and stirred. A few seconds later, the mix was placed into two centrifuge tubs and 70, 160 or 280 μl of acetaldehyde were fast released into the solutions. After that, samples were centrifuged and the paste obtained was dried overnight. All samples were evaluated in triplicate and stored in hermetically closed flasks at 23° C.

40 mL glass vials were filled with 1 mL of distilled water and into this a 2-mL glass vial with 0.1 g of inclusion complexes was placed. Vials were immediately closed with Mininert® valves (Supelco, Bellefonte, Pa.). After 1, 3, 5 and 7 days, hexanal concentrations released from the IC to the vial headspaces were measured using a 65-μm PDMS/DVB SPME fiber (Supelco, Bellefonte, Pa.) and Hewlett-Packard 6890 Gas Chromatograph (Agilent Technology, Palo Alto, Calif.) equipped with FID and a HP-5 column. Quantification of hexanal in the headspace was determined on the basis of previously prepared calibration curves. Three repetitions were obtained for each IC.

Fourteen-day-old surface-plated cultures of Colletotricumn acutatum, Alternaria alternata and Botrytis cinerea in plastic Petri dishes (9 cm diameter), were filled aseptically with PDA medium (Potato Dextrose Agar) (Sigma-Aldrich Corp. (Saint Louis, Mo.)), and mixed with a few drops of sterile distilled water. Ten mL of each were collected inside plastic tubes which were shaken hard to dislodge spores from mycelia. The spores and cell suspensions were then filtered with sterile cheesecloth to remove debris such as mycelia and condensed-agar fragments and the aliquot was concentrated to 10⁶ c.f.u./mL (spore*mL⁻¹), which were counted by the Neubauer improved method (Bright-Line Hemacytometer, Hausser Scientific, Horsham, Pa.).

Smaller Petri dishes (5.5 cm diameter) were also filled aseptically with PDA. Upon solidification of the agar medium, a drop of spores of each suspension was inserted as a drop in the centre of the well with a 100 μL Oxford Autoclavable Benchmate Pipette (Nichiryo, Japan). Finally, the Petri dishes were placed inside 1 L-glass jars which were closed with twist-off tops and stored at 23° C. These were used as the controls.

Other jars were modified for inserting and withdrawing of the volatiles obtained from the bioassays. For that, jars tops were modified by introducing a septum through which the volatile was inserted on a small piece of glass which was suspended 4 cm above the bottom. The same device was used to withdraw samples during storage. Volatile compounds were introduced into the jars by means of a 10 μL liquid-tight syringe (Hamilton, Reno, Nev.) through the rubber septum. Desired doses of liquid acetaldehyde and hexanal were applied neat to the piece of glass mentioned above and then evaporated. Three Petri dishes were set up to test each concentration of the compound. All jars were stored at 23° C.

The same modified jars, but with 500-mL capacity, were used to test the complexes of β-cyclodextrin-hexanal and β-cyclodextrin-acetaldehyde. 0.7 and 1.2 g of a complex of acetaldehyde and hexanal, respectively, were inserted into the jars using a piece of aluminium foil. Both complexes and aluminium foil were previously sterilized under UV light. Jars were stored at 23° C.

Radial growth of the cultures in controls and treated samples were evaluated daily by measuring the surface area of the plate occupied by the colony during incubation or by measuring the length of the colony. Due to the optical transparency of both glass and Petri dish materials, these measurements could be carried out without opening the jars. Each assay was tested in triplicate and the area means calculated were analyzed statistically by analysis of variance. The delay in fungal growth was expressed as direct radial growth of cultures in cm² or cm as a percentage of colony growth by comparing samples exposed to the anti-fungal treatments with the controls.

The concentration of volatiles in the vapor phase to which the fungus was exposed was estimated by solid phase micro-extraction (SPME) sampling of the headspace and GC analysis. The vapor phase was generated by evaporation of the tested liquid compound from the small piece of glass or volatiles released from the β-cyclodextrin complexes. The withdrawal of volatiles from the jars was done by inserting a 65-μm PDMS/DVB SPME fiber (Supelco, Bellefonte, Pa.) through the septum of the device inserted in the twist-off top. The trapped volatiles were desorbed at the splitless injection port of the GC. The concentration of hexanal in the headspace was determined on the basis of previously prepared calibration curves after incubation for 1, 3, 5 and 7 days at 23° C.

PLA resin (94% lactide) was dried overnight at 60° C. The polymeric material and ICs were weighed as per the calculated compositions and mixed together and fed to the extruder barrel of a micro twin screw extruder equipped with an injection molder system (TS/I-02, DSM, The Netherlands). After extrusion, the melted materials were moved through a preheated cylinder to the mini injection molder to obtain the desired specimen samples. The resin samples were melted and pressed into films using a hydraulic press (Hydraulic Unit Model # 3925, Caver Laboratory Equipment, Wabash, Ind.) supported by two stainless steel plates covered with TEFLON™ sheet protectors.

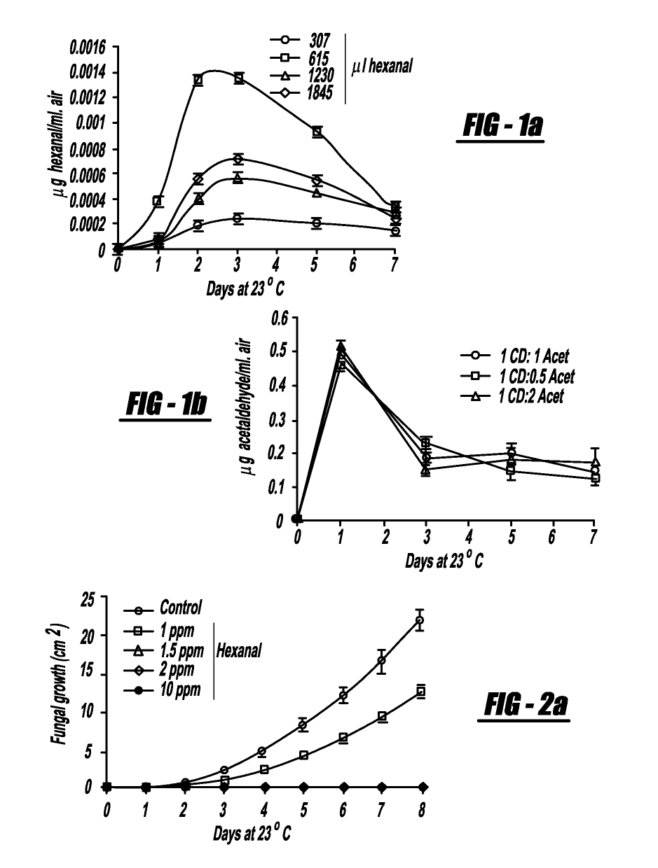

FIG. 1a shows the volatile concentration of hexanal released from the different ICs during 7 days of storage at 23° C. The microencapsulated content of hexanal was affected by the amount of volatile inserted in the paste CD-distilled water. Thus, hexanal was successfully microencapsulated into β-cyclodextrins in molar relationships of 1:1, equivalent to 615 μL of volatile. However, for acetaldehyde, the complex effectiveness was independent of the inserted amount of volatile in the paste CD-distilled water, as shown in FIG. 1b.

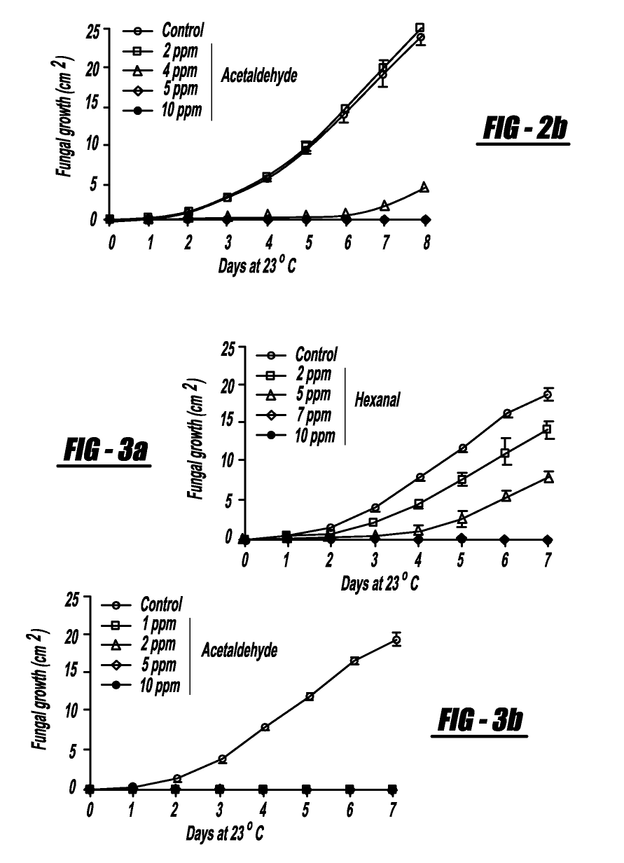

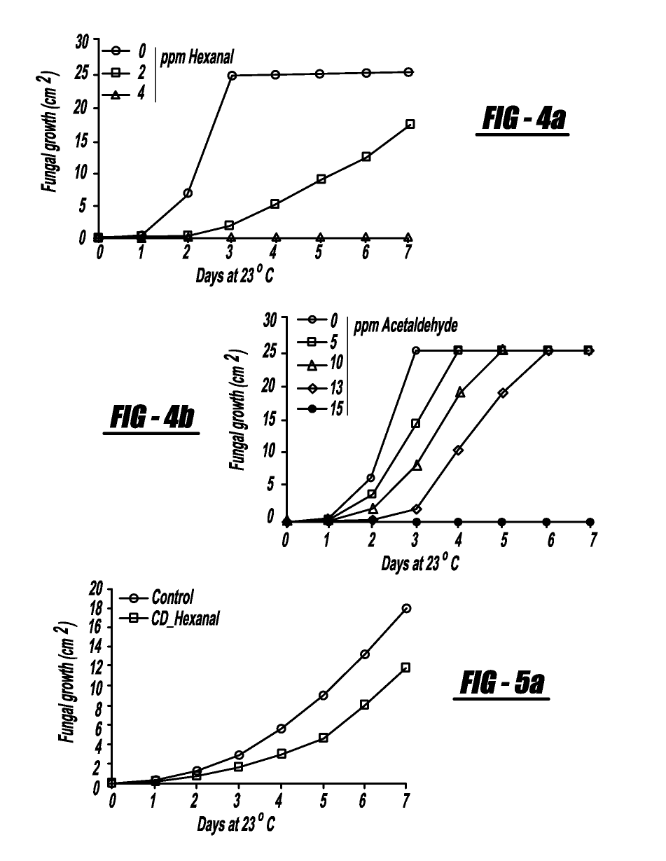

The addition of acetaldehyde and hexanal to the bioassay system headspace significantly (p<0.05) prevented and/or decreased fungal growth. Effectiveness of these volatiles was dependent on type of fungus and amount of volatile inserted. FIGS. 2-4 show the growth of C. acutatum, A. alternata and B. cinerea when exposed to different concentrations of hexanal (FIGS. 2a, 3a, and 4a) and acetaldehyde (FIGS. 2b, 3b, and 4b) during 7 days at 23° C. As can be seen, hexanal completely inhibited C. acutatum, A. alternata and B. cinerea growth at concentrations of 0.91, 1.91 and 1.05 μg/mL air, respectively (equivalent to 1.5, 7 and 4 ppm of volatile).

Therefore, a high level of effectiveness was showed against C. acutatum. Acetaldehyde showed its highest effectiveness against A. alternata. A concentration of 0.10 μg/mL air was enough to avoid fungal growth. Higher acetaldehyde concentrations, 0.44 μg/mL air, were necessary against C. acutatum. Any amount tested of acetaldehyde was able to prevent B. cinerea growth. The effectiveness showed by acetaldehyde and hexanal on tested fungi could be related to the different fungal membrane affinities with the antimicrobials.

Hexanal, because of its greater effectiveness was chosen to be encapsulated in β-cyclodextrins and tested against C. acutatum and B. cinerea. For the same reason, acetaldehyde was tested against A. alternata.

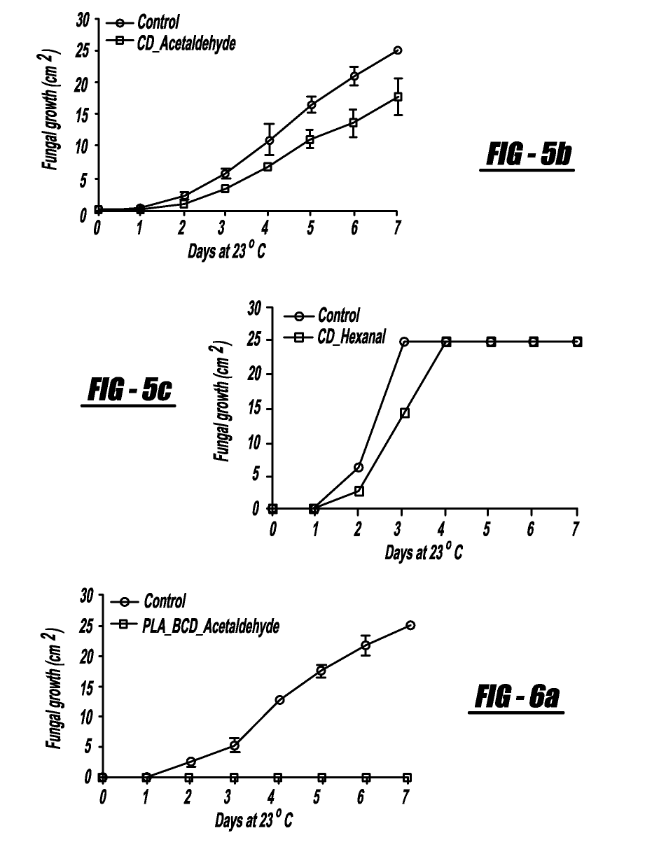

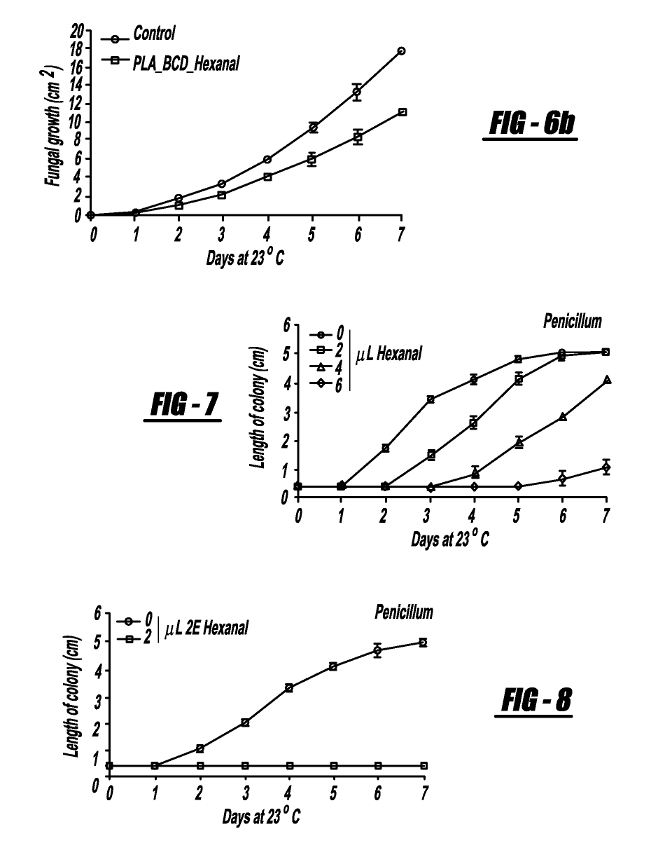

The anti-fungal effects of ICs were investigated at concentrations of 1.2 g and 1.8 g for C. acutatum and B. cinerea, respectively, and 0.7 g for A. alternata. These amounts were necessary to reach a concentration of 0.91 and 1.05 μg hexanal/mL air and 0.10 μg acetaldehyde/mL air inside the bioassays systems. As can be seen in FIGS. 5a and 5b, C. acutatum and A. alternata growth were reduced by over 43% and 35%, respectively. ICs of hexanal assayed against B. cinerea growth (see FIG. 5c) were not effective.

FIGS. 6 (a) and (b) shows the effectiveness of the anti-fungal biodegradable films developed against C. acutatum and A. alternata during 7 days at 23° C. Higher amounts of ICs were used in these films, e.g., 1.4 and 0.9 g of ICs for hexanal and acetaldehyde, respectively. As can be seen, C. acutatum was reduced by over 40% while growth of A. alternata was totally prevented.

Both hexanal and acetaldehyde showed different anti-fungal capacity depending on concentration and fungus tested. All assayed ICs effectively retarded growth of fungus. Antifungal and biodegradable films were effective against the growth of the most common rot pathogens in berries.

In accordance with another embodiment of the present invention, increasing amounts of anti-fungal compounds (e.g., hexanal or acetaldehyde) are added to a paste of CD and distilled water (10% w/w). After proper centrifugation, the formed complexes are poured off and dried in an oven for 15 hours. All mixtures are placed in closed flasks prior to use.

Petri dishes (PDA) containing a constant concentration of fungal spores (10⁶ CFU of Collectotrichum acutatum, Alternaria alternata, and Botrytis cinerea) are placed inside aseptic jars. Before closing off the jars with twist-off tops, adequate amounts of ICs (CD-anti-fungal volatiles) are inserted. The jars are incubated for 8-18 days at different temperatures (3, 10 and 20° C.). Other fungal cultures are stored directly without volatiles at those temperatures to be used as controls. Storage at 3 or 10° C. is done to emulate temperature fluctuations that a fungus might experience during the fresh produce commercial chain. Storage at 20° C. is done to emulate worst storage conditions (e.g., room temperature). Growth of the cultures in both controls and treatments are evaluated daily by measuring radial growth of the fungus in two perpendicular directions. The extent of fungal growth is expressed as area of growth in cm² or as a percentage of colonial growth compared to the controls.

The concentration of individual compounds in the vapor phase to which the fungus is exposed is estimated. Concentrations of hexanal and acetaldehyde in the headspaces are measured using solid phase micro-extraction (SPME) and GC analysis (HP 6890 series GC equipped with an FID). The vapor phases are generated by evaporation of a single tested liquid. SPME fibers are exposed to the jar headspace for 10 minutes and the trapped volatiles are immediately desorbed (e.g., for 10 minutes) at the splitless injection port of a GC. Quantification of volatiles is determined daily using GC analysis for 8-14 days at storage temperatures of 3, 10 and 20° C. The amounts of the different volatile compounds in the head space are calculated on the basis of previously prepared calibration curves.

Alternatively, the IC's can also be prepared by stirring over 15 hours at room temperature before being dried.

In accordance with still another embodiment of the present invention, growth of Penicillium sp. and Aspergillus Niger was evaluated in vitro in the presence of hexanal, acetaldehyde and 2E-hexenal. The fungistatic and fungicidal effects of the pure volatiles were evaluated and presented below.

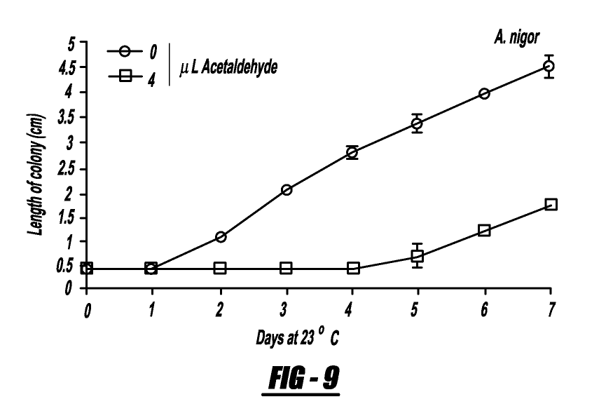

FIGS. 7-9 show the effectiveness of hexanal, 2E-hexenal and acetaldehyde against Penicillium and Aspergillus growth. Penicillium was slowed down depending on hexanal concentration assayed. Thus, fungal development was delayed by over 18 and 74%, respectively, by insertions of 4 and 6 μL of this volatile after 7 days of storage at 23° C. The volatile 2E-hexenal showed a higher effectiveness. Penicillium was not able to grow during 1 week at 23° C. after exposition at 1 μL of this volatile. Exposition of A. niger at 4 μL of acetaldehyde gave rise to a delay in its growth by over 66% after 7 days at room temperature. Both fungi were exposed to all three volatiles and all showed different effectiveness depending on the type of fungus and the type of volatile.

All tested volatiles are listed as being approved as food additives by the US Food and Drug Administration (e.g., see http://vm.cfsan.fda.gov/%7Edms/eafus.html; access date Jul. 26, 2006). Also, the oral mammalian LD 50 of all of them reached inside the jars and shown as effective are lower than those accepted as limited concentrations (ORL-MAM LD50_{Hexanal} 3700 mg Kg⁻¹, ORL-MAM LD50_{Acetaldehyde} 250 mg Kg⁻¹ and ORL-MAM LD50_{2E-hexenal} 780 mg Kg⁻¹).

It should be appreciated that the technology of the present invention permits the insertion of many different types of volatiles as long as they can be incorporated in β-CD and/or similar materials.

With respect to the types of plastic materials to which the technology of the present invention can be applied, initial tests were done with polyesters. However, this technology should work well in polyolefins, as well as other suitable polymeric and/or plastic materials. These materials can be shaped into films, packaging (e.g., containers, lids and/or the like), and/or the like.

Any off-odors would be dependent on the volatile tested and the amount inserted. For obtaining that information, further trials would need to be conducted to see if the off-odors associated with different concentrations of acetaldehyde, ethyl acetate and 2E-hexenal are modified in the tested product.

Additionally, the β-cyclodextrins alone and/or incorporated in polymers such as but not limited to polyolefins, polyesters and biopolymers can also be used to slowly release aroma and/or flavor compounds, such as but not limited to acetates and esters.

Furthermore, the encapsulated anti-fungal compounds can be: (1) used alone (e.g., brought into proximity to the produce); (2) incorporated into film materials that are used in the packing and/or storing of produce; and/or (3) incorporated into packaging that is used for the packing and/or storing of produce.

In addition to the anti-fungal compounds previously described, the technology of the present invention can be used to encapsulate different chemical volatile compounds, including those having anti-fungal properties, such as but not limited to cinnamic acid, 1-methylcyclopropene, isoprene, terpenes, as well as any other volatile organic compounds (VOCs) which could be later released. By way of a non-limiting example, additional possible compounds can include 2-nonanone, cis-3-hexen-1-ol, methyl jasmonate, benzaldehyde, propanal, butanal, ethanol, acetic acid, allyl-isothiocyanate (AITC), thymol, eugenol, citral, vanillin, trans-cinnamaldehyde, cinnamic acid, salicylic acid, furfural, β-ionone, 1-nonanol, nonanal, 3-hexanone, 2-hexen-1-ol, 1-hexanol, and/or the like.

Additionally, the anti-fungal compounds (e.g., ICs) can be incorporated into non-biodegradable materials as well, including but not limited to polyethylene terephthalate (PET), polystyrene (PS) and/or the like.

While the invention has been described with reference to an exemplary embodiment, it will be understood by those skilled in the art that various changes can be made and equivalents can be substituted for elements thereof without departing from the scope of the invention. In addition, many modifications can be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for inhibiting fungal growth on post harvest fresh produce, comprising:
a volatile compound; and
a cyclodextrin;
wherein the volatile compound is encapsulated by the cyclodextrin.

2. The invention according to claim 1, wherein the volatile compound is selected from the group consisting of acetaldehyde, hexanal, 2E-hexanal, and combinations thereof.

3. The invention according to claim 1, wherein the volatile compound is selected from the group consisting of cinnamic acid, 1-methylcyclopropene, isoprene, terpenes, 2-nonanone, cis-3-hexen-1-ol, methyl jasmonate, benzaldehyde, propanal, butanal, ethanol, acetic acid, allyl-isothiocyanate, thymol, eugenol, citral, vanillin, trans-cinnamaldehyde, cinnamic acid, salicylic acid, furfural, β-ionone, 1-nonanol, nonanal, 3-hexanone, 2-hexen-1-ol, 1-hexanol, and combinations thereof.

4. The invention according to claim 1, wherein the cyclodextrin is selected from the group consisting of α cyclodextrins, β cyclodextrins, γ cyclodextrins, and combinations thereof.

5. The invention according to claim 1, wherein the volatile compound exhibits anti-fungal properties.

6. The invention according to claim 1, wherein the volatile compound is released over a period of several days from the cyclodextrin.

7. The invention according to claim 1, wherein the volatile compound inhibits the growth of bacteria selected from the genus Colletotrichum, Alternaria, Botrytis, Penicillium, Aspergillus, and combinations thereof.

8. The invention according to claim 1, wherein the encapsulated volatile compound is incorporated into a biodegradable material.

9. The invention according to claim 8, wherein the biodegradable material is polylactic acid.

10. The invention according to claim 8, wherein the biodegradable material is formed into a structure selected from the group consisting of films, containers, lids, and combinations thereof.

11. The invention according to claim 1, wherein the encapsulated volatile compound is incorporated into a non-biodegradable material.

12. The invention according to claim 11, wherein the non-biodegradable material is a plastic material.

13. The invention according to claim 11, wherein the non-biodegradable material is formed into a structure selected from the group consisting of films, containers, lids, and combinations thereof.

14. The invention according to claim 1, wherein the fresh produce is berries.

15. A system for inhibiting fungal growth on post harvest fresh produce, comprising:
a volatile compound selected from the group consisting of acetaldehyde, hexanal, 2E-hexanal, and combinations thereof; and
a cyclodextrin, wherein the cyclodextrin is selected from the group consisting of α cyclodextrins, β cyclodextrins, γ cyclodextrins, and combinations thereof;
wherein the volatile compound is encapsulated by the cyclodextrin.

16. The invention according to claim 15, wherein the volatile compound further comprises a compound selected from the group consisting of cinnamic acid, 1-methylcyclopropene, isoprene, terpenes, 2-nonanone, cis-3-hexen-1-ol, methyl jasmonate, benzaldehyde, propanal, butanal, ethanol, acetic acid, allyl-isothiocyanate, thymol, eugenol, citral, vanillin, trans-cinnamaldehyde, cinnamic acid, salicylic acid, furfural, β-ionone, 1-nonanol, nonanal, 3-hexanone, 2-hexen-1-ol, 1-hexanol, and combinations thereof.

17. The invention according to claim 15, wherein the volatile compound exhibits anti-fungal properties.

18. The invention according to claim 15, wherein the volatile compound is released over a period of several days from the cyclodextrin.

19. The invention according to claim 15, wherein the volatile compound inhibits the growth of bacteria selected from the genus Colletotrichum, Alternaria, Botrytis, Penicillium, Aspergillus, and combinations thereof.

20. The invention according to claim 15, wherein the encapsulated volatile compound is incorporated into a biodegradable material.

21. The invention according to claim 20, wherein the biodegradable material is polylactic acid.

22. The invention according to claim 20, wherein the biodegradable material is formed into a structure selected from the group consisting of films, containers, lids, and combinations thereof.

23. The invention according to claim 15, wherein the encapsulated volatile compound is incorporated into a non-biodegradable material.

24. The invention according to claim 23, wherein the non-biodegradable material is a plastic material.

25. The invention according to claim 23, wherein the non-biodegradable material is formed into a structure selected from the group consisting of films, containers, lids, and combinations thereof.

26. The invention according to claim 15, wherein the fresh produce is berries.

27. A system for inhibiting fungal growth on post harvest fresh produce, comprising:
a volatile compound selected from the group consisting of acetaldehyde, hexanal, 2E-hexanal, and combinations thereof; and
a cyclodextrin, wherein the cyclodextrin is selected from the group consisting of α cyclodextrins, β cyclodextrins, γ cyclodextrins, and combinations thereof;
wherein the volatile compound is encapsulated by the cyclodextrin;
wherein the volatile compound exhibits anti-fungal properties;
wherein the volatile compound is released over a period of several days from the cyclodextrin.

28. The invention according to claim 27, wherein the volatile compound further comprises a compound selected from the group consisting of cinnamic acid, 1-methylcyclopropene, isoprene, terpenes, 2-nonanone, cis-3-hexen-1-ol, methyl jasmonate, benzaldehyde, propanal, butanal, ethanol, acetic acid, allyl-isothiocyanate, thymol, eugenol, citral, vanillin, trans-cinnamaldehyde, cinnamic acid, salicylic acid, furfural, β-ionone, 1-nonanol, nonanal, 3-hexanone, 2-hexen-1-ol, 1-hexanol, and combinations thereof.

29. The invention according to claim 27, wherein the volatile compound inhibits the growth of bacteria selected from the genus Colletotrichum, Alternaria, Botrytis, Penicillium, Aspergillus, and combinations thereof.

30. The invention according to claim 27, wherein the encapsulated volatile compound is incorporated into a biodegradable material.

31. The invention according to claim 30, wherein the biodegradable material is polylactic acid.

32. The invention according to claim 30, wherein the biodegradable material is formed into a structure selected from the group consisting of films, containers, lids, and combinations thereof.

33. The invention according to claim 27, wherein the encapsulated volatile compound is incorporated into a non-biodegradable material.

34. The invention according to claim 33, wherein the non-biodegradable material is a plastic material.

35. The invention according to claim 33, wherein the non-biodegradable material is formed into a structure selected from the group consisting of films, containers, lids, and combinations thereof.

36. The invention according to claim 27, wherein the fresh produce is berries.
